(19) United States
(12) Patent Application Publication
(10) Pub. No.: US 2008/0006375 A1
(43) Pub. Date: Jan. 10, 2008

(54) Ornamental screen system

(76) Inventor: Ralph C. Meadows, Myrtle Beach, SC (US)

Correspondence Address: P. JEFF MARTIN;SUITE 200, 2120 SEA MOUNTAIN HWY, P.O. BOX 4369, N. MYRTLE BEACH, SC, 29597, US

(21) Appl. No.: 11/481,496

(22) Filed: Jul. 6, 2006

(51) Int. Cl. E06B 9/24

(52) U.S. Cl. 160/371

(57) ABSTRACT

An ornamental screen system is provided which includes a kit which allows a homeowner or occupant to enhance the aesthetic and architectural beauty of his frame-and-screen structures through the use of decorative screening while also excluding the home of insects and bugs.

### RELATED APPLICATIONS

There are no previously filed, nor currently any co-pending applications, anywhere in the world.

### BACKGROUND OF THE INVENTION

1. Field of the Invention

The present invention relates generally to framed screens for use in the windows and doors of people's homes to exclude crawling or flying insects, bugs and the like and, more particularly, to an ornamental screen system comprised of a kit which includes screen material embellished with distinctive ornamentation to enhance the aesthetic and architectural beauty of frame-and-screen structures while also excluding the home of insects and bugs.

2. Description of the Related Art

Currently there are a number of commercially available insect and bug screens of various designs. These designs are capable of being mounted over door and window openings. Other screen systems are designed to slide on tracks across a door or window opening.

More complex screen systems have become available in recent years which include retractable screen systems, snap-in screen and frame devices, insect screen devices which utilize various attachment and mounting means, and retainer strip devices for affixing screen to doors and windows.

However, none of the aforementioned screen systems and devices have disclosed an ornamental screen system in the form of a kit which includes screening material adapted to be ornamented via an image transfer method with distinctive ornamentation in order to enhance the aesthetic and architectural beauty of user's frame-and-screen structures. Unlike currently available screen systems, the present invention allows user the flexibility to cover framed openings with custom-embellished screen material according to user's image choice or favorite design.

Accordingly, a need has arisen for an ornamental screen system comprised of screen material adapted to be embellished with personalized and distinctive ornamentation to enhance the aesthetic and architectural beauty of frame-and-screen structures while also excluding the home of insects and bugs in a manner which is quick, easy, and efficient. The development of the ornamental screen system fulfills this need.

### SUMMARY OF THE INVENTION

Therefore, it is an object of the present invention to provide an ornamental screen system comprised of a kit which allows a homeowner or occupant to enhance the aesthetic and architectural beauty of his frame-and-screen structures through the use of decorative screening while also excluding the home of insects and bugs.

It is another object of the present invention to provide a kit which includes screen material made of meshed wires adapted to admit air but exclude insects.

It is another object of the present invention to provide meshed wires constructed from a flexible textile material.

It is another object of the present invention to provide screen material adapted to be adorned with distinctive ornamentation via an image transfer method.

It is another object of the present invention to enhance the aesthetic and architectural beauty of frame-and-screen structures such as boathouses, doors, windows, pool enclosures, porches, garage doors, gazebos, mobile home screened-porch units, fireplace screens, and partitions.

It is another object of the present invention to provide distinctive ornamentation which includes decorative images comprised of colorful digital images, photos, pictures, patterns, symbols, and/or indicia adapted to be transposed to screen material which reflect a particular theme.

It is another object of the present invention to allow for selected decorative images to be enlarged or reduced when necessary so as to accommodate dimensional parameters of screen material selected for mounting over opening(s) in frame-and-screen structures.

It is another object of the present invention to provide an ornamental screen system adapted to be mounted to framework formed of a variety of materials.

It is still another object of the present invention to provide an ornamental screen system being commercially available as a kit.

Briefly described according to one embodiment of the present invention, an ornamental screen system is disclosed. The ornamental screen system comprises a screen material made of meshed wires adapted to admit air but exclude insects. The meshed wires are constructed from a flexible textile material selected from the group which includes but is not limited to plastic, fiberglass, vinyl-coated fiberglass, polyester, plain weave monofilament polyester, nylon, vinyl-coated polyester, polyvinyl chloride (PVC), PVC-coated polyester, and combinations thereof, and stainless steel, aluminum, bronze, and brass.

The screen material is adapted to be adorned via an image transfer method with distinctive ornamentation in order to enhance the aesthetic and architectural beauty of frame-and-screen structures such as a boathouse, doors, windows, pool enclosures, porches, garage doors, gazebos, mobile home screened-porch units, fireplace screens, and partitions.

The distinctive ornamentation comprises decorative images comprised of colorful digital images, photos, pictures, patterns, symbols, and/or indicia adapted to be transposed to screen material which reflect a particular theme. Theme is broadly construed to comprise a variety of scenes selected by user depicting holidays, geographical locations, formations, aquatic scenes, wild and exotic animals, domestic animals, sports, prehistoric reptiles, cartoon characters, outer space, cultural images and symbols representative, and any other images selectively desired by user to be transposed to screen material in order to enhance the aesthetic and architectural beauty of user's frame-and-screen structures. Thus, the ornamental screen system allows user the flexibility to cover framed openings in user's porches, doors, windows, garages, and the like with screen material which is custom-embellished with a decorative image according to user's choice or favorite design, such as a family photo, a tropical scene, or a holiday design.

Decorative image selected by user is transposed to screen material via an image transfer method. The decorative image may be enlarged or reduced in size if necessary so as to accommodate dimensional parameters of screen material selected for mounting over opening(s) in frame-and-screen structures such as doors and windows during the transpositional process.

Boathouses, doors, windows, pool enclosures, porches, garage doors, gazebos, mobile home screened-porch units, fireplace screens, and partitions which are provided with window and/or door openings surrounded by a framework and adapted to be covered by screen material finds application for the ornamental screen system. Also acceptable for use with the ornamental screen system are retractable or roll-up screen apparatuses, sliding doors and windows, and standard hinged doors having door openings, wherein door openings or cavities of such doors and windows and sliding doors and windows are dimensioned to correspond to dimensions of a frame to be covered by a screen material and mounted within such door openings.

The ornamental screen system is adapted to be mounted to framework formed of a variety of materials which include but are not limited to wood, vinyl, aluminum, and plastic, such as foamed, closed-cell plastic. Other materials include thermoplastic, plastic polymers, and plastic copolymers.

The ornamental screen system is intended to be made commercially available as a kit, wherein kit is provided to enhance the aesthetic and architectural beauty of frame-and-screen structures. Kit may also be utilized simply for screen replacement or repair. The kit comprises a package for housing screen material, spline, a screen and spline installation tool, and an instruction leaflet which provides detailed instructions for installing screen material to selected frame-and-screen structures.

In order to accommodate various types of frame-and-screen structures which may require varied forms or methods of screen installation other than wheel-type screen and spline installation implements, alternative kits are provided. The alternative kits are therefore adapted to accommodate frame-and-screen structures which utilize or require methods for screen installation other than wheel-type screen and spline installation implements. These particular methods include but are not limited to the following: snap-in devices for removably securing a screen to a window or door frame; window or door frame devices which utilize magnetic attraction to affix screen to window or door frames; window or door frames incorporating corner keys, internal keys, and the like which are adapted to mate with frame segments; devices incorporating adhesive or hook-and-loop fasteners to removably secure a screen to a window or door frame; and retainer strip devices incorporating base strips and overlay strips having respective protrusions, grooves, and channels adapted to mate and releasably lock.

The first alternative kit comprises a package for housing screen material, spline, a plurality of magnets, and an instruction leaflet.

A second alternative kit comprises a package for housing screen material, hook-and-loop fasteners, and an instruction leaflet.

A third alternative kit comprises a package for housing screen material, spline, a coupling means, and an instruction leaflet.

A fourth alternative kit comprises a package for housing a frame structure dimensionally-sized so as to accommodate a consumer's desired measure for mounting frame structure within a framed opening, screen material, spline, a screen and spline installation tool, and an instruction leaflet. It is envisioned that fourth alternative kit may also comprise a plurality of frame structures and corresponding screen material for purposes of installing frame structures into a plurality of user-desired framed openings.

In the event user desires to use a decorative image not provided for in the preferred kit and alternative kits, such as a digitally-created image or picture taken by user utilizing a digital camera, or other pictures, prints, photos and other images provided by user adapted to be transposed to screen material, a fifth alternative kit is envisioned. The fifth alternative kit comprises a package for housing screen material, spline, a screen and spline installation tool, a plurality of magnets, hook-and-loop fasteners, a coupling means, a frame structure dimensionally-sized so as to accommodate user's desired measure for mounting a frame structure within a framed opening, and an instruction leaflet. The fifth alternative kit allows a user the flexibility and uniqueness to install screen material to selected framed openings of frame-and-screen structures with screening which is custom-embellished with a decorative image according to user's preference, thereby enhancing the aesthetic and architectural beauty of user's frame-and-screen structures with distinct, personalized adornment. Thus, user is provided with limitless possibilities concerning the scene desired and ultimately selected for display. For example, user may select a digital image which includes but is not limited to user's family, pet, or a photo depicting a holiday gathering or trip to a tropical island.

The use of the present invention allows a homeowner to enhance the aesthetic and architectural beauty of his frame-and-screen structures through the use of decorative screening while also excluding the home of insects and bugs in a manner which is quick, easy, and efficient.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a top plan view of the ornamental screen system illustrating screen material embellished with distinctive ornamentation, according to the preferred embodiment of the present invention;

FIG. 2 is a perspective view of a door typically adapted for use with the present invention, according to the preferred embodiment;

FIGS. 3-9 are isometric views illustrating various decorative images reflecting assorted themes shown transposed atop screen material, according to the preferred embodiment;

FIGS. 10-20 illustrate various frame-and-screen structures adapted for use with the present invention, according to the preferred embodiment;

FIG. 21 illustrates the kit, according to the preferred embodiment of the present invention;

FIG. 22 illustrates the screen and spline installation tool in use to form a mating channel of screen material in the groove of a frame, according to the preferred embodiment;

FIG. 23 illustrates the screen and spline installation tool in use to force spline within mating channel of the screen, according to the preferred embodiment;

FIG. 24 is a side elevational view of the screen and spline installation tool, according to the preferred embodiment;

FIG. 25 is a front side elevational view of the screen and spline installation tool illustrating the convex periphery of the first wheel, according to the preferred embodiment;

FIG. 26 is a front side elevational view of the screen and spline installation tool illustrating the concave periphery of the second wheel, according to the preferred embodiment;

FIG. 27 is a cross-sectional view of a frame-and-screen structure illustrating the frame groove thereof;

FIG. 28 illustrates a device incorporating hook-and-loop fasteners to removably secure a screen to a window or door frame;

FIG. 29 illustrates a retainer strip device incorporating base strips and overlay strips with respective protrusions, grooves and channels adapted to mate and releasably lock;

FIG. 30 illustrates a snap-in device for removably securing a screen to a window or door frame;

FIG. 31 illustrates a retractable or roll-up screen apparatus;

FIG. 32 illustrates a window frame device which utilizes magnetic attraction to affix a screen to a window frame;

FIG. 33 illustrates a window frame apparatus incorporating connector elements adapted to mate with frame segments;

FIG. 34 illustrates a first alternative kit embodiment;

FIG. 35 illustrates a second alternative kit embodiment;

FIG. 36 illustrates a third alternative kit embodiment;

FIG. 37 illustrates a fourth alternative kit embodiment;

FIG. 38 illustrates a fifth alternative kit embodiment; and

FIGS. 39 and 40 illustrate a sixth alternative kit embodiment.

### DESCRIPTION OF THE PREFERRED EMBODIMENT

### 1. Detailed Description of the Figures

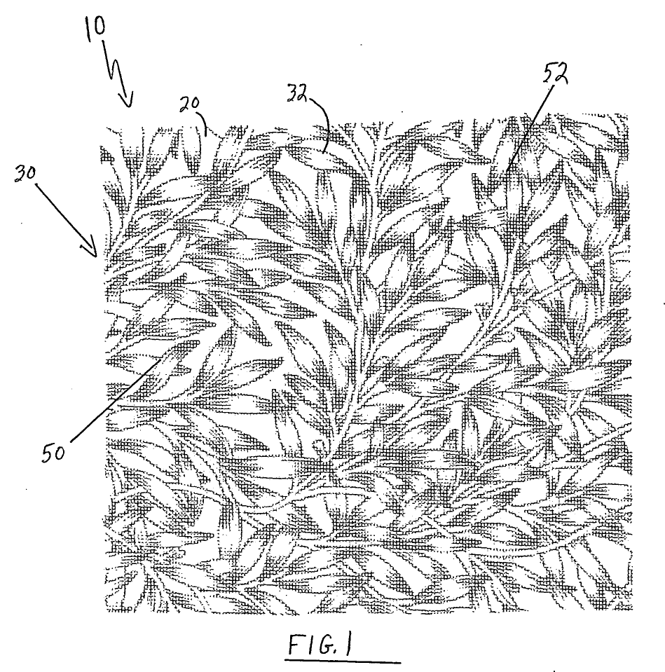

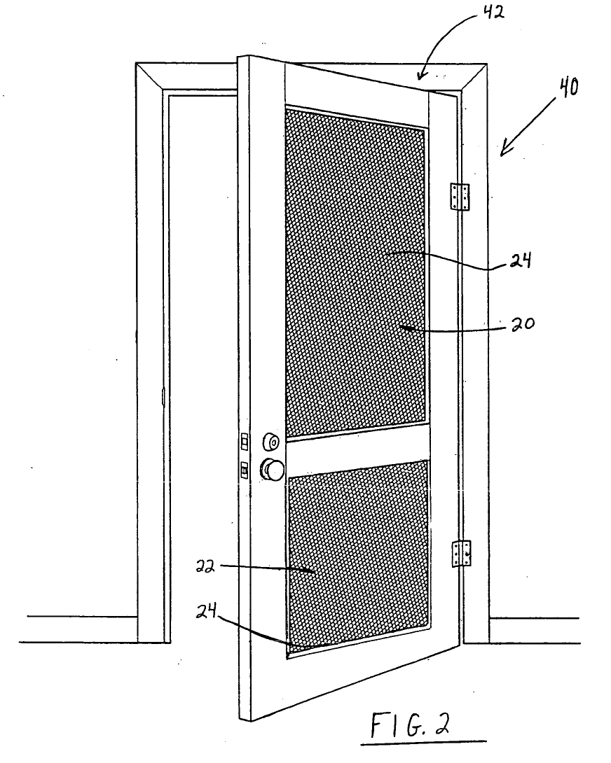

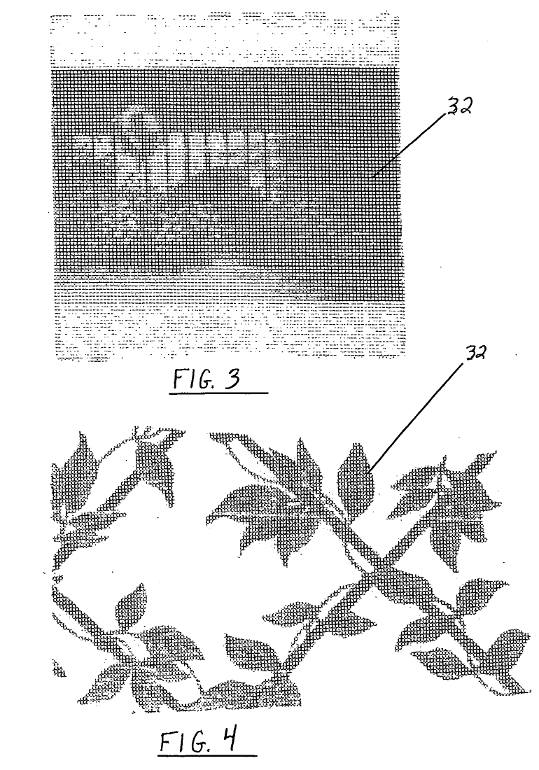

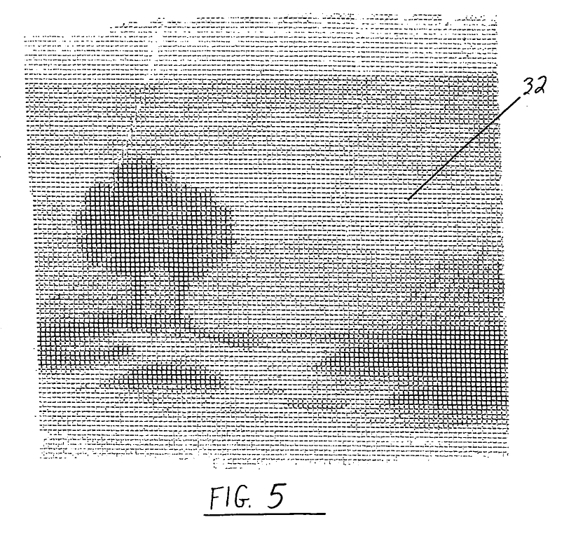

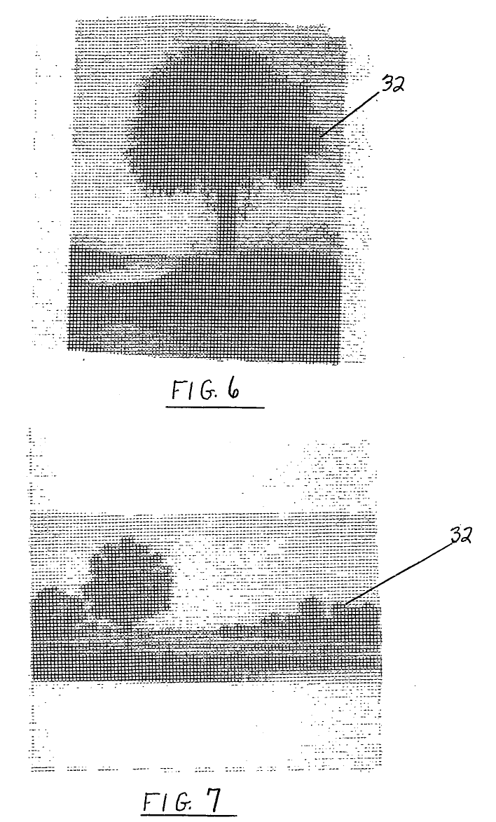

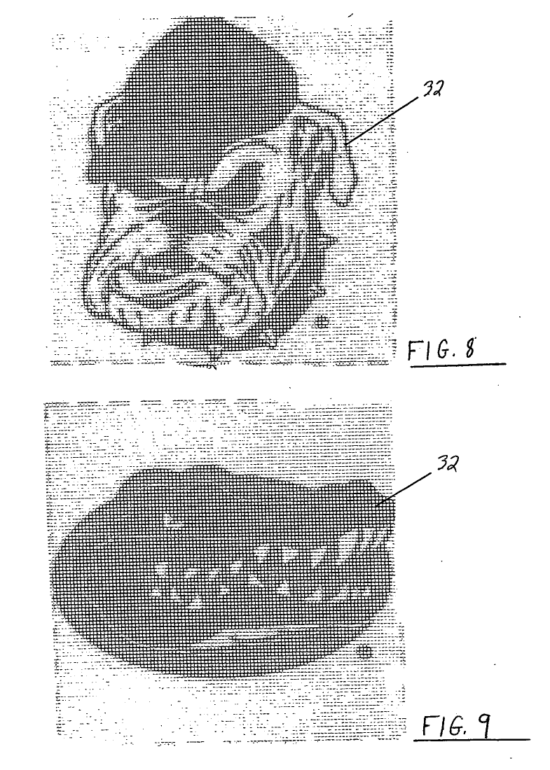

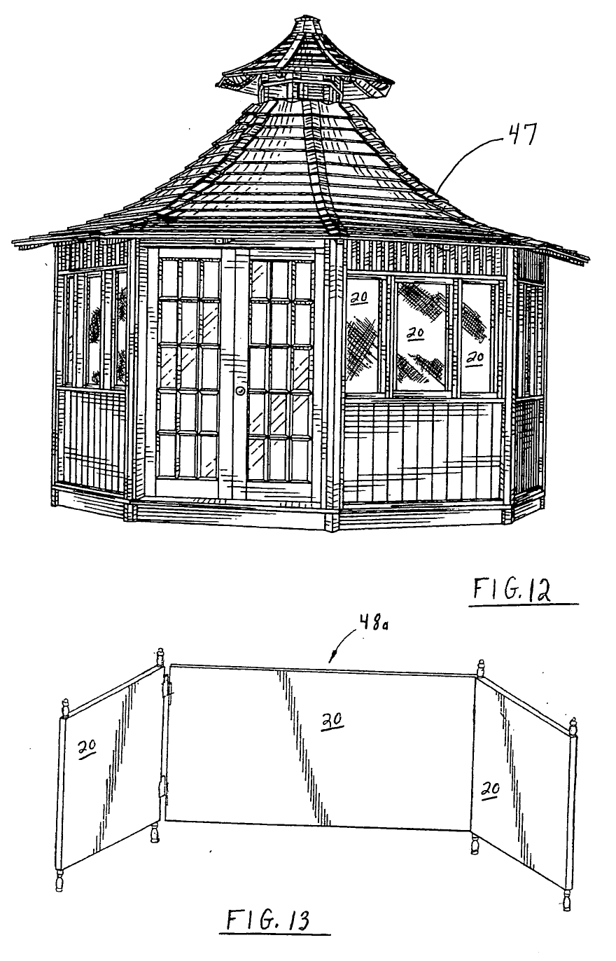

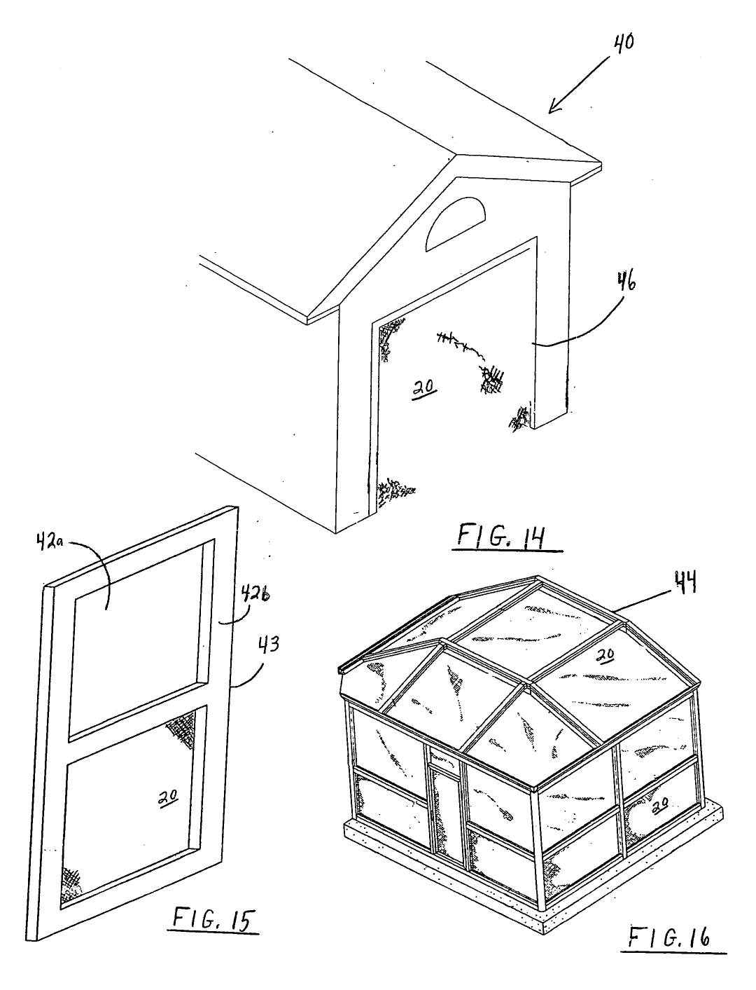

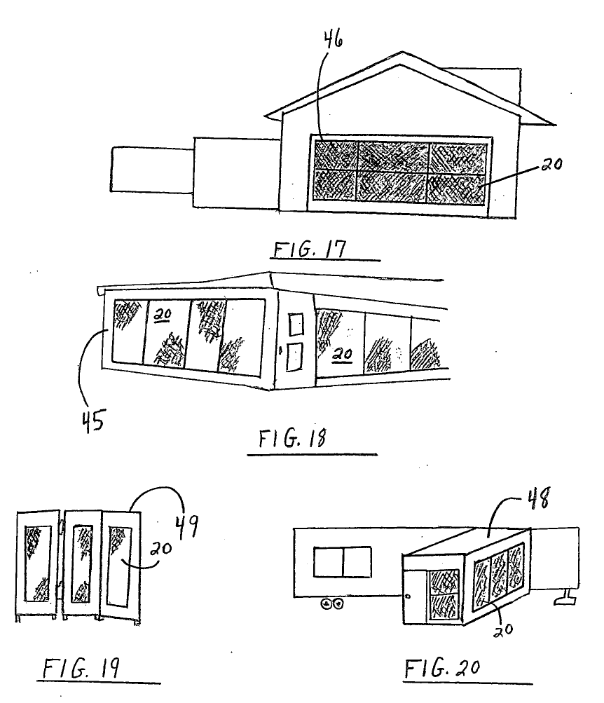

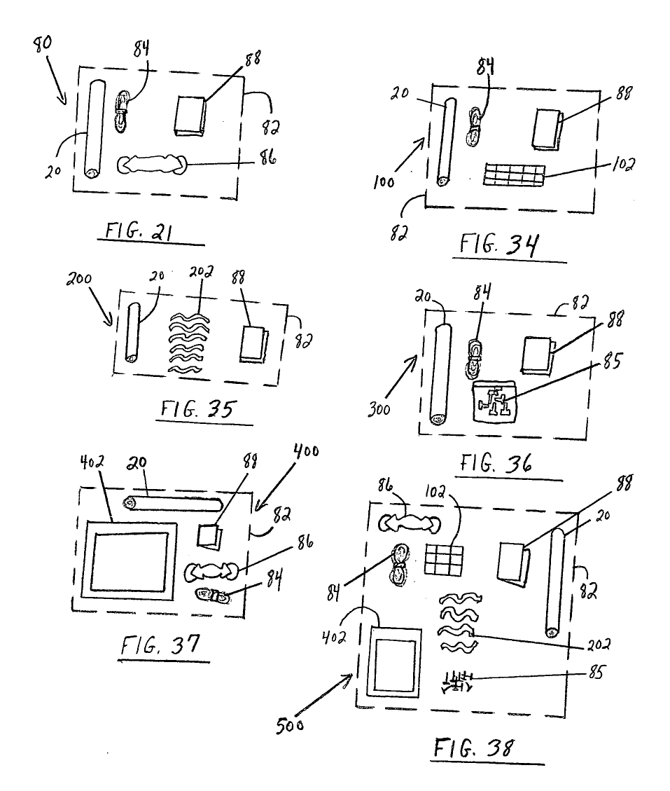

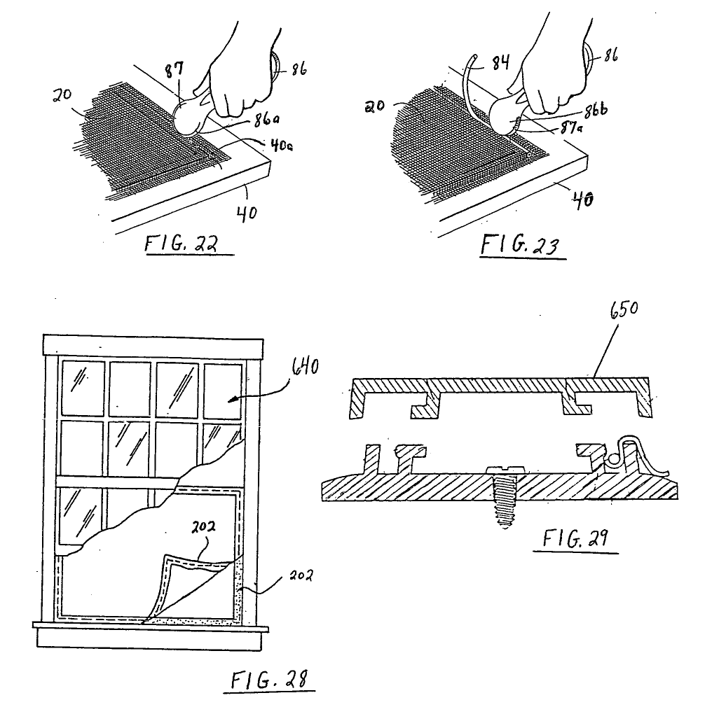

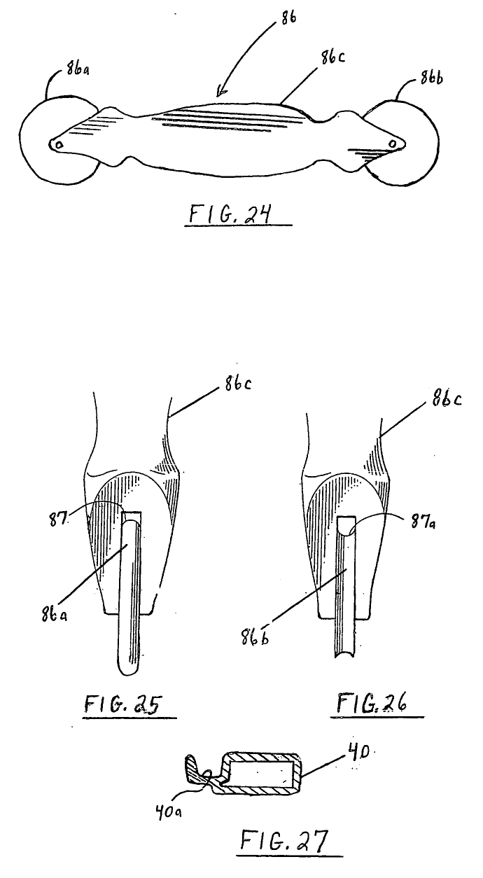

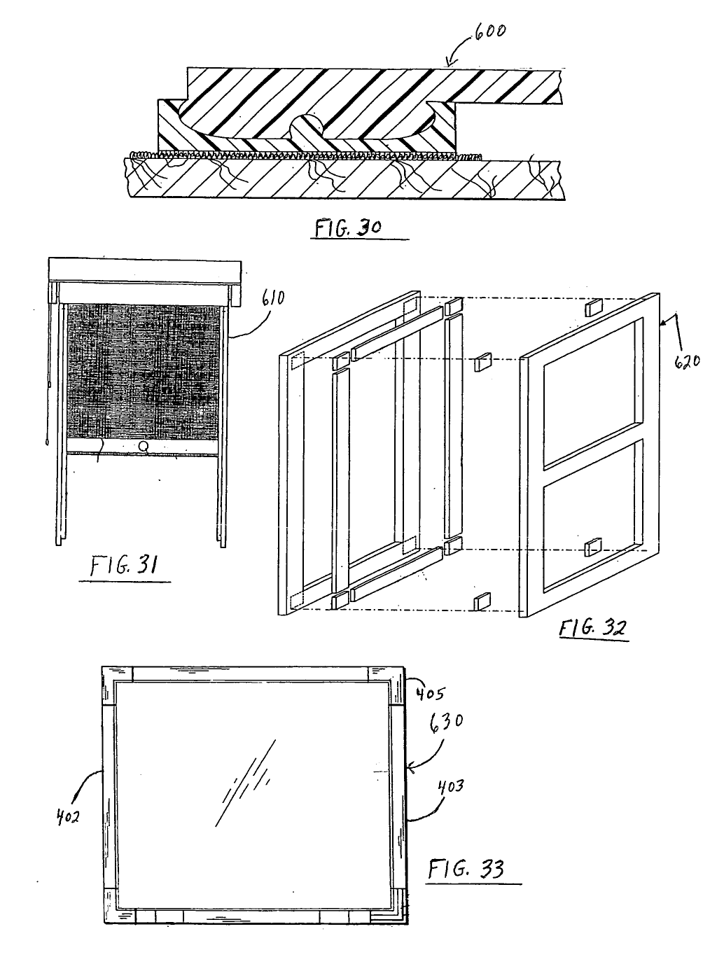

Referring now to FIGS. 1-33, an ornamental screen system 10 is shown, according to the present invention, comprised of screen material 20 made of meshed wires 22 adapted to admit air but exclude insects. The meshed wires 22 are constructed from a flexible textile material 24 selected from the group which includes but is not limited to plastic, fiberglass, vinyl-coated fiberglass, polyester, plain weave monofilament polyester, nylon, vinyl-coated polyester, polyvinyl chloride (PVC), PVC-coated polyester, and combinations thereof, and stainless steel, aluminum, bronze, and brass. Vinyl-coated polyester is much heavier and stronger than traditional fiberglass or aluminum screening. Vinyl-coated polyester is resistant to tears and damage caused by household pets, therefore making vinyl-coated polyester screening ideal for use as pet screening. PVC-coated polyester screening or “solar screening” is utilized to reduce ultraviolet heat and rays so as to minimize harmful effects therefrom, such as skin cancer and furniture and carpet damage. Bronze screening is comprised of a metal content of 90% copper and 10% zinc. Brass screening is also comprised of a metal content of 90% copper and 10% zinc, however, in contrast to bronze screening, brass screening is fabricated using a heavier/thicker wire, or wire of a lower gauge size.

The screen material 20 is adapted to be adorned via an image transfer method 60 with distinctive ornamentation 30 in order to enhance the aesthetic and architectural beauty of frame-and-screen structures 40 such as a boathouse 41, doors 42, windows 43, pool enclosures 44, porches 45, garage doors 46, gazebos 47, mobile home screened-porch units 48, fireplace screens 48a, and partitions 49. The distinctive ornamentation 30 comprises decorative images 32 comprised of colorful digital images, photos, pictures, patterns, symbols, and/or indicia adapted to be transposed to screen material 20 which reflect a particular theme 50. Theme 50 is broadly construed to comprise a variety of scenes 52 selected by user depicting the following: holidays 52a and symbols therefor, such as Christmas, Thanksgiving, Fourth of July, Easter, New Years, Halloween, and the like; geographical locations, formations, and objects 52b, such as plant and tree life, a lighthouse, a tropical scene, a snowy-winter scene, or a rain forest; nautical or aquatic scenes 52c which include aquatic life such as fish, whales, sharks, and dolphins; wild and exotic animals 52d; domestic animals 52e, such as a digital image of one's pet(s); sports 52f, including motor sports and sports symbols therefor; sports equipment, sports venues, symbols, and teams; prehistoric reptiles 52g; cartoon characters 52h; outer space 52i and objects representative thereof, such as celestial images, stars, moon, planets and the like; cultural images and symbols representative thereof 52j, such as Southwestern and tribal cultures; family photos 52k; and any other images selectively desired by user to be transposed to screen material 20 in order to enhance the aesthetic and architectural beauty of user's frame-and-screen structures 40. Thus, the ornamental screen system 10 allows user the flexibility to cover framed openings in user's porches, doors, windows, garages, and the like with screen material 20 which is custom-embellished with a decorative image 32 according to user's choice or favorite design, such as a family photo, a tropical scene, or a holiday design.

Decorative image 32 selected by user is transposed to screen material 20 via an image transfer method 60. Image transfer methods 60 include heat transfer, heat transfer utilizing paper-dyed backing, direct transfer via digital printer, and other standard methods commonly utilized in the image transfer and transpositional industry adapted to facilitate image transfer or image transposition to screen material 20. In order to facilitate optimum image transfer, the particular method employed is contingent upon screen material's 20 fabrication material. For example, where screen material 20 is fabricated of vinyl-coated polyester, the decorative image 32 may be transposed to such screen material 20 by direct transfer via digital printer. Where screen material 20 is fabricated of polyester, the decorative image 32 may be transposed to such screen material 20 by heat transfer. It is also recognized that various screen materials 20 are adapted to utilize more than one type of image transfer method 60 for facilitating image transfer or image transposition thereto. The decorative image 32 may be enlarged or reduced in size if necessary so as to accommodate dimensional parameters of screen material 20 selected for mounting over opening(s) in frame-and-screen structures 40 such as doors 42 and windows 43 during the transpositional process.

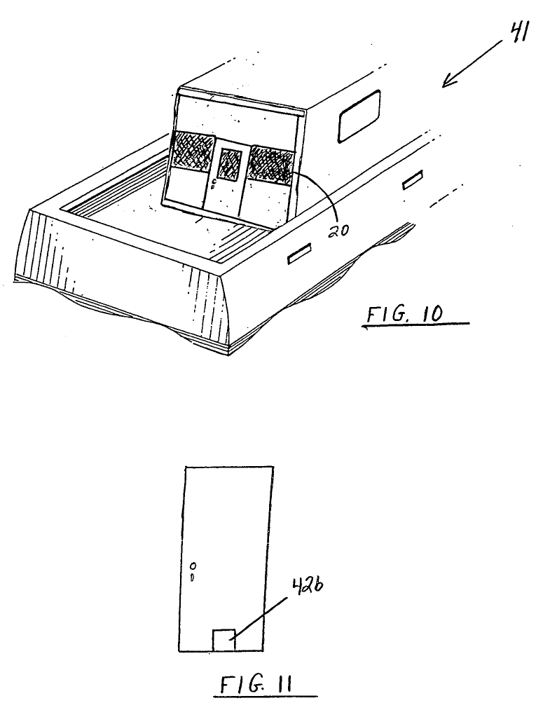

Referring now more specifically to FIGS. 10-20, the frame-and-screen structures 40 adapted for use with the ornamental screen system 10 described above will be further described hereinbelow.

A boathouse 41, doors 42, windows 43, pool enclosures 44, porches 45, garage doors 46, gazebos 47, mobile home screened-porch units 48, fireplace screens 48a, and partitions 49 which are provided with window and/or door openings 42a surrounded by a framework 41b and adapted to be covered by screen material 20 finds application for the ornamental screen system 10. Also acceptable for use with the ornamental screen system 10 are retractable or roll-up screen apparatuses, sliding doors and windows, and standard hinged doors having door openings 42a, wherein door openings 42a or cavities of such doors and windows and sliding doors and windows are dimensioned to correspond to dimensions of a frame 70 to be covered by a screen material 20 and mounted within such door openings 42a. The frame 70 is defined as being a unitary piece 72 or a plurality of segments 73 connected via connecting members 74, such as corner keys 75 and internal keys. The term doors 42 is also intended to encompass pivoting or hinged pet doors 42b.

The ornamental screen system 10 is adapted to be mounted to framework 41b formed of a variety of materials which include but are not limited to wood, vinyl, aluminum, and plastic, such as foamed, closed-cell plastic. Other materials include thermoplastic, plastic polymers, and plastic copolymers. An example of a foamed, closed-cell plastic is foamed, closed-cell polyvinyl chloride.

Referring now to FIGS. 1-27, the ornamental screen system 10 is intended to be made commercially available as a kit 80, wherein kit 80 is provided to enhance the aesthetic and architectural beauty of frame-and-screen structures 40. Kit 80 may also be utilized simply for screen replacement or repair. The kit 80 comprises a package 82 for housing screen material 20, spline 84, a screen and spline installation tool 86, and an instruction leaflet 88 which provides detailed instructions for installing screen material 20 to selected frame-and-screen structures 40.

Spline 84 is formed of a material adapted to suitably hold screen material 20 within a frame groove 40a of a frame-and-screen structure 40. The screen and spline installation tool 86, hereinafter referred as tool 86, is a unitary article formed of a single piece of high impact plastic material, capable of being fabricated via a molding process, such as injection molding. The tool 86 defines an elongated configuration having a first wheel 86a integrally connected to a second wheel 86b by an intermediate portion 86c. Intermediate portion 86c is shaped so as to form a handle. The first wheel 86a defines a convex periphery 87 adapted for forming a mating channel in the screen material 20 over the frame groove 40a. The first wheel 86a is supported in a fork between which first wheel 86a is rotatable on an axis. The second wheel 86b has a concave periphery 87a adapted to match a cross-sectional shape of the spline 84. The second wheel 86b is supported in a fork between which second wheel 86b is rotatable on an axis. The convex periphery of first wheel 86a is adapted to be rolled or slid over the screen material 20 in order to force screen material 20 into the mating channel. The concave periphery of second wheel 86b is adapted to guide and force the spline 84 downwardly into frame groove 40a, thereby securing screen material 20 to frame-and-screen structure 40.

Referring now to FIGS. 28-33, in order to accommodate various types of frame-and-screen structures 40 which may require varied forms or methods of screen installation other than wheel-type screen and spline installation implements, alternative kits 100 are provided. The alternative kits 100 are therefore adapted to accommodate frame-and-screen structures 40 which utilize or require methods for screen installation other than wheel-type screen and spline installation implements, wherein other methods include but are not limited to the following: snap-in devices 600 for removably securing a screen to a window or door frame; retractable or roll-up screen apparatuses 610; window or door frame devices which utilize magnetic attraction to affix screen to window or door frames 620, such as a gasket sandwiched between a screen frame and a window frame and a plurality of magnets for joining and removably affixing such components; window or door frames 630 incorporating corner keys, internal keys, and the like which are adapted to mate with frame segments; devices incorporating adhesive or hook-and-loop fasteners 640 to removably secure a screen to a window or door frame; and retainer strip devices 650 incorporating base strips and overlay strips having respective protrusions, grooves, and channels adapted to mate and releasably lock.

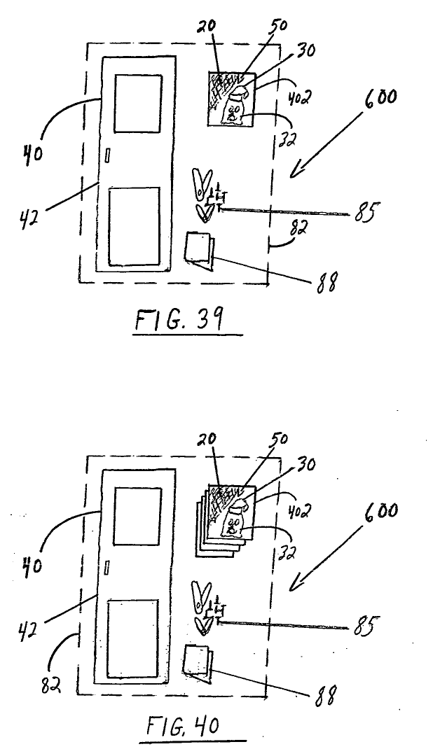

Referring now more specifically to FIG. 34, the first alternative kit 100 comprises a package 82 for housing screen material 20, spline 84, a plurality of magnets 102, and an instruction leaflet 88 which provides detailed instructions for installing screen material 20 to selected frame-and-screen structures 40. The first alternative kit 100 is not adapted for use with frame-and-screen structures 40 fabricated of aluminum or other material incapable of facilitating magnetic attraction.

Referring now more specifically to FIG. 35, a second alternative kit 200 comprises a package 82 for housing screen material 20, hook-and-loop fasteners 202, and an instruction leaflet 88 which provides detailed instructions for installing screen material 20 to selected frame-and-screen structures 40.

Referring now more specifically to FIG. 36, a third alternative kit 300 comprises a package 82 for housing screen material 20, spline 84, a coupling means 85, such as a plurality of spring clips, swivel keepers, and nails or screws, and an instruction leaflet 88 which provides detailed instructions for installing screen material 20 to selected frame-and-screen structures 40.

Referring now more specifically to FIG. 37, a fourth alternative kit 400 comprises a package 82 for housing a frame structure 402 dimensionally-sized so as to accommodate a consumer's desired measure for mounting frame structure 402 within a framed opening, screen material 20, spline 84, a screen and spline installation tool 86, and an instruction leaflet 88 which provides detailed instructions for installing screen material 20 to frame structure 402 and for installing frame structure 402 into a desired framed opening adapted to accommodate dimensionally the frame structure 402. It is envisioned that fourth alternative kit 400 may also comprise a plurality of frame structures 402 and corresponding screen material 20 for purposes of installing frame structures 402 into a plurality of user-desired framed openings.

For purposes of this disclosure, screen material 20, as described hereinabove as being included as a component of preferred kit 80 and alternative kits 100, 200, 300, 400, is available in a variety of dimensions according to user's dimensional requirements. Screen material 20 may also be packaged into a tightly-rolled configuration in order to facilitate compact storage. Further, screen material 20 is adapted with distinctive ornamentation 30 comprised of a decorative image 32 selected according to user preference. More specifically, kit 80 and kits 100, 200, 300, 400 are packaged with screen material 20 transposed via image transfer method 60 with a decorative image 32 adorned or embellished with one of various themes 50, such as holidays 52a, geographical locations, formations, and objects 52b, aquatic scenes 52c, and other themes 50 described above in greater detail. Thus, user or consumer selects kit 80 or kits 100, 200, 300, 400 not only for repair or replacement, but more importantly, according to the particular kit 80, 100, 200, 300, 400 which provides the particular theme 50 user desires as well as the specific dimensions required.

Alternatively, in the event user desires to use a decorative image 32 not provided for in kit 80, 100, 200, 300, or 400, such as a digitally-created image or picture taken utilizing a digital camera, or other pictures, prints, photos and other images adapted to be transposed to screen material 20, a fifth alternative kit 500 (FIG. 38) is envisioned. The fifth alternative kit 500 allows a user the flexibility and uniqueness to install screen material 20 to selected framed openings of frame-and-screen structures 40 with screening 20 which is custom-embellished with a decorative image 32 provided by user, thereby enhancing the aesthetic and architectural beauty of user's frame-and-screen structures 40 with distinct, personalized adornment. Thus, user is provided with limitless possibilities concerning the scene 52 desired and ultimately selected for display. For example, user may select a digital image which includes but is not limited to user's family, pet, or a photo depicting a holiday gathering or trip to a tropical island.

The fifth alternative kit 500 comprises a package 82 for housing screen material 20, spline 84, a screen and spline installation tool 86, a plurality of magnets 102, hook-and-loop fasteners 202, a coupling means 85, a frame structure 402 dimensionally-sized so as to accommodate user's desired measure for mounting a frame structure 402 within a framed opening, and an instruction leaflet 88. The instruction leaflet 88 provides detailed instructions which includes informing user of acceptable forms of images adapted for transposition to screen material 20, company contact information, fees, and method of shipment regarding the image selected by user for transposition to screen material 20, and delivery of final product 600 to user, wherein final product 600 is defined as screen material 20 custom-embellished with a decorative image 32 according to user's choice or desire. The instruction leaflet 88 also provides detailed instructions for installing screen material 20 to selected frame-and-screen structures 40. The instruction leaflet 88 further provides detailed instructions for installing screen material 20 to a frame structure 402 and for installing the frame structure 402 into the desired framed opening.

The fifth alternative kit 500 may further comprise a plurality of frame segments 403 connected via connector elements 405 such as corner keys to form a frame structure 402 adapted to be installed with screen material 20 and dimensionally-adapted for mounting within a framed opening of a selected frame-and-screen structure(s) 40.

Finally, referring to FIGS. 39-40, a sixth alternate kit 600 comprises a package 82 for housing a frame-and-screen structure 40 such as a door 42, couplings 85, an instruction leaflet 88, and a frame structure 402 adapted to be removably mounted to frame-and-screen structure 40. Couplings 85 are adapted to facilitate securement of frame structure 402 to frame-and-screen structure 40. The frame structure 402 includes screen material 20 mounted thereto. Screen material 20 is adapted with distinctive ornamentation 30 comprised of a decorative image 32 selected according to user preference. More specifically, screen material 20 is embellished with a decorative image 32 comprising one of various themes 50, such as holidays 52a, geographical locations, formations, and objects 52b, aquatic scenes 52c, and other themes 50 described above in greater detail. It is intended that screen material 20 of each kit 600 is independently embellished with a particular theme 50. A plurality of kits 600 are envisioned in order that a variety of themes 50 are available for selection and purchase by user according to preference. Thus, consumer makes kit 600 selection according to a desired theme 50 of choice. For example, user desires a kit 600 having screen material 20 embellished with a winter holiday 52a theme 50. Thus, user selects and purchases a particular kit 600 which includes screen material 20 embellished with a Christmas theme 50.

Referring specifically to FIG. 40, kit 600 is envisioned to include a plurality of frame structures 402 adapted to be removably mounted to frame-and-screen structure 40, wherein each of the plurality of frame structures 402 is mounted with screen material 20, thereby providing an ornamental screen structure insert 604. Each screen material 20 mounted to each frame structure 402 is independently embellished with distinctive ornamentation 30 comprised of a decorative image 32 so as to provide a plurality of ornamental screen structure inserts 604 each mounted with screen material 20 embellished with a different theme 50. Thus, kit 600 includes a plurality of interchangeable ornamental screen structure inserts 604 allowing user to quickly, easily, and efficiently substitute or interchange ornamental screen inserts 604 as user desires.

### 2. Operation of the Preferred Embodiment

To use the present invention, user opens the package 82 of kit 80, and removes the screen material 20, spline 84, screen and spline installation tool 86, and instruction leaflet 88 therefrom. User first reads installation instructions and then places ornamental screen material 20 over framed opening of selected frame-and screen structure 40. User next grasps screen and spline installation tool 86 around the intermediate portion 86c thereof, and using the convex periphery of first wheel 86a of tool 86, user rolls and slides the wheel 86a over the ornamental screen material 20 in order to force screen material 20 into the frame groove 40a of frame-and screen structure 40 so as to form a mating channel. Next, utilizing the concave periphery of second wheel 86b of tool 86, user guides and forces the spline 84 downwardly into mating channel or frame groove 40a, thereby securing ornamental screen material 20 to frame-and-screen structure 40.

The use of the present invention allows a homeowner or occupant to enhance the aesthetic and architectural beauty of his frame-and-screen structures through the use of decorative screening while also excluding the home of insects and bugs in a manner which is quick, easy, and efficient.

Therefore, the foregoing description is included to illustrate the operation of the preferred embodiment and is not meant to limit the scope of the invention. As one can envision, an individual skilled in the relevant art, in conjunction with the present teachings, would be capable of incorporating many minor modifications that are anticipated within this disclosure. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents. Therefore, the scope of the invention is to be broadly limited only by the following Claims.

What is claimed is:

1. An ornamental screen system comprising:
a screen material, said screen material is constructed of meshed wires adapted to admit air but exclude insects, said screen material is adapted to be embellished with distinctive ornamentation via an image transfer method so as to provide a decorative or ornamental screen for enhancing aesthetic and architectural beauty of frame-and-screen structures.

2. The ornamental screen system of claim 1, wherein said meshed wires are constructed from a flexible textile material.

3. The ornamental screen system of claim 2, wherein said flexible textile material includes plastic, fiberglass, vinyl-coated fiberglass, polyester, plain weave monofilament polyester, nylon, vinyl-coated polyester, polyvinyl chloride, PVC-coated polyester, and combinations thereof.

4. The ornamental screen system of claim 2, wherein said flexible textile material includes stainless steel, aluminum, bronze, and brass.

5. The ornamental screen system of claim 1, wherein said distinctive ornamentation comprises decorative images comprised of colorful digital images, photos, pictures, patterns, symbols, and/or indicia adapted to be transposed to said screen material, wherein said decorative images reflect a particular theme.

6. The ornamental screen system of claim 5, wherein said theme comprises a variety of scenes for selection by user.

7. The ornamental screen system of claim 1, wherein said image transfer method includes heat transfer, heat transfer utilizing paper-dyed backing, and direct transfer via digital printer.

8. The ornamental screen system of claim 1, wherein said screen material is adapted to be mounted over framed openings of said frame-and-screen structures, wherein said frame-and-screen structures include doors, windows, pool enclosures, porches, garage doors, gazebos, mobile home screened-porch units, fireplace screens, boathouses and partitions.

9. A kit for enhancing aesthetic and architectural beauty of frame-and-screen structures, comprising:
a package;
at least one screen material;
spline;
a screen and spline installation tool; and
an instruction leaflet.

10. The kit of claim 9, wherein said package is adapted for housing said screen material, said spline, said screen and spline installation tool, and said instruction leaflet, and wherein said instruction leaflet provides detailed instructions for installing said screen material to user-selected frame-and-screen structures, and wherein said spline is formed of a material adapted to suitably hold said screen material within a frame groove of said frame-and-screen structure, said screen and spline installation tool defines an elongated configuration having a rotatable first wheel integrally connected to a rotatable second wheel by an intermediate portion, wherein said first wheel defines a convex periphery adapted for forming a mating channel in said screen material over the frame groove, said second wheel has a concave periphery adapted to match a cross-sectional shape of said spline, and wherein said convex periphery of said first wheel is adapted to be rolled or slid over said screen material in order to force said screen material into the mating channel, said concave periphery of said second wheel is adapted to guide and force said spline downwardly into the mating channel, thereby securing said screen material to said frame-and-screen structure.

11. The kit of claim 10, wherein said screen material is constructed of meshed wires adapted to admit air but exclude insects, said meshed wires are constructed from a flexible textile material, and wherein said screen material is embellished with distinctive ornamentation, thereby providing a decorative or ornamental screen for enhancing aesthetic and architectural beauty of said frame-and-screen structures.

12. The kit of claim 10, wherein said distinctive ornamentation comprises decorative images comprised of colorful digital images, photos, pictures, patterns, symbols, and/or indicia, said decorative images are adapted to be transposed to said screen material via an image transfer method, wherein said decorative images reflect a particular theme.

13. The kit of claim 12, wherein said theme comprises a variety of scenes being selectable by user.

14. The kit of claim 9, wherein said screen material is adapted to be mounted over framed openings of said frame-and-screen structures, wherein said frame-and-screen structures include doors, windows, pool enclosures, porches, garage doors, gazebos, mobile home screened-porch units, fireplace screens, boathouses and partitions.

15. A kit for enhancing aesthetic and architectural beauty of frame-and-screen structures, wherein said kit is adapted to accommodate said frame-and-screen structures which utilize various devices and methods for installing screen which include snap-in devices for removably securing a screen to a window or a door frame, retractable or roll-up screen apparatuses, window or door frame devices which utilize magnetic attraction to affix screen to window or door frames, window or door frames incorporating connector elements which are adapted to mate with frame segments, devices incorporating adhesive or hook-and-loop fasteners to removably secure a screen to a window or a door frame, and retainer strip devices, said kit comprising:
a screen material;
an instruction leaflet; and
a package for housing said screen material, said instruction leaflet and additional accessories and components.

16. The kit of claim 15, wherein said kit further comprises spline and a plurality of magnets.

17. The kit of claim 15, wherein said kit further comprises hook-and-loop fasteners.

18. The kit of claim 15, wherein said kit further comprises spline and a plurality of couplings.

19. The kit of claim 15, wherein said kit further comprises spline, couplings, a screen and spline installation tool, and at least one frame structure being dimensionally-sized so as to accommodate a desired measure for mounting said frame structure within a framed opening, wherein said screen material is adapted dimensionally to mount to said frame structure.

20. The kit of claim 15, wherein said screen material is embellished with distinctive ornamentation, or each of said screen material is adapted to be custom-embellished with a decorative image provided by user, thereby enhancing aesthetic and architectural beauty of user's said frame-and-screen structures with distinct, personalized adornment.

21. The kit of claim 15, further comprising more than one screen material, spline, couplings, a screen and spline installation tool, and more than one frame structure being dimensionally-sized so as to accommodate a desired measure for mounting said frame structure within a framed opening, wherein said screen material is adapted dimensionally to mount to said frame structure, and wherein each said screen material is independently embellished with distinctive ornamentation.

22. A kit for enhancing aesthetic and architectural beauty of frame-and-screen structures, comprising:
a package;
a frame-and-screen structure;
a frame structure, said frame structure is adapted to be removably mounted to said frame-and-screen structure;
couplings; and
an instruction leaflet.

23. The kit of claim 22, wherein said package is adapted to house said frame-and-screen structure, said frame structure, said couplings, and said instruction leaflet, and wherein said couplings are adapted to facilitate securement of said frame structure to frame-and-screen structure, said frame structure includes a screen material mounted thereto.

24. The kit of claim 23, wherein said screen material is adapted with distinctive ornamentation comprised of a decorative image selected according to user preference, said decorative image comprises one of various themes, thus allowing user to select said kit according to user's theme of choice.

25. The kit of claim 22, further comprising a plurality of frame structures adapted to be removably mounted to said frame-and-screen structure, wherein each of said plurality of frame structures is mounted with said screen material, thereby providing an ornamental screen structure insert.

26. The kit of claim 25, wherein said screen material of each of said plurality of frame structures is independently embellished with distinctive ornamentation comprised of a decorative image so as to provide a plurality of ornamental screen structure inserts, wherein each of said plurality of ornamental screen structure inserts is mounted with said screen material embellished with a different theme, thereby providing a kit which includes a plurality of interchangeable ornamental screen structure inserts which allows a user to quickly, easily, and efficiently substitute or interchange said ornamental screen inserts.

27. The kit of claim 22, wherein said frame-and-screen structure is a door.
